(19) United States
(12) Patent Application Publication
(10) Pub. No.: US 2006/0039440 A1
(43) Pub. Date: Feb. 23, 2006

(54) Exciting laser resonators with RF energy

(76) Inventor: Markus Schwandt, Gerlingen (DE)

Correspondence Address: FISH & RICHARDSON PC, P.O. BOX 1022, MINNEAPOLIS, MN, 55440-1022, US

(21) Appl. No.: 11/202,379

(22) Filed: Aug. 12, 2005

(30) Foreign Application Priority Data
Aug. 12, 2004 (DE) 10 2004 039 082.7

(51) Int. Cl. H01S 3/08

(52) U.S. Cl. 372/92

(57) ABSTRACT

A laser includes an RF generator, a laser resonator and a cable connection provided between the RF generator and the laser resonator. The output impedance respective output and input impedances of two components directly connected by a cable of the cable connection are different. The cable impedance and length of the cable are selected such that the output impedance of an upstream one of the components is adjusted to the input impedance of the other of the two components. The two components may be any combination of the RF generator, laser resonator, and one or two matchboxes.

### CLAIM FOR PRIORITY

The present application claims priority to German Patent Application No. 10 2004 039 082.7, filed Aug. 12, 2004. The contents of the prior application are incorporated herein in their entirety by reference.

### TECHNICAL FIELD

The present invention concerns the excitement of laser resonators with RF energy, and particularly an arrangement comprising an RF generator, a laser resonator, and a cable connection provided between the RF generator and the laser resonator.

### BACKGROUND

In the generation of RF energy for exciting gas lasers, one differentiates between freely oscillating generators, i.e. generators whose internal impedance and oscillation frequency depend on the load impedance, and generators with fixed frequency, e.g. 13.56 MHz. The latter usually have an internal impedance of 50 ohms. These systems also use cables with a cable impedance of 50 ohms for transferring energy between generator and laser resonator. The input impedance of the laser resonator depends, in addition to excitation frequency and gas composition, mainly on the excitation geometry and is generally not 50 ohms. The laser resonator is adjusted to the output impedance of the RF generator via one or more matchboxes which are disposed in the laser resonator (i.e. internally) and/or outside of the laser resonator (i.e. externally). The length of the cable of RF-excited gas lasers is selected to ensure optimum laser ignition behaviour.

It is desirable to reduce the number of energy-transferring and impedance-transforming components in an arrangement of the above-mentioned type.

### SUMMARY

According to one aspect of the invention, a cable connection interconnecting an RF generator and laser resonator includes a cable which is selected to have an impedance and length such that the output impedance of the RF generator is adjusted to the input impedance of the laser resonator.

By “adjusted to” I mean that the output impedance of the RF generator, at the opposite or output end of the cable (i.e., at the laser resonator or associated matchbox) is matched to the input impedance of the laser resonator or associated matchbox. If, for example, the output impedance of the RF generator is 50 Ohm and the input impedance of the laser resonator is 60 Ohm, a cable is chosen with an impedance and length such that the generator output impedance of 50 Ohm is transformed to 60 Ohm at the distal end of the cable, to match the input impedance of the resonator.

The cable connection simultaneously assumes the task of transferring energy and transforming impedances between the output impedance of the RF generator and the input impedance of the laser resonator with the result that at least one matchbox can be omitted, thereby saving costs and gaining space due to the omitted matchbox. The output impedance of the RF generator corresponds to the input impedance of the cable and the input impedance of the laser resonator corresponds to the output impedance of the cable when no matchboxes are interconnected. The electrical properties of the cable connection depend on the impedance of the cable connection, the impedance at the input of the cable connection, the impedance at the output of the cable connection, the electric connection among the cables or against other potentials in the circuit (ground or electrically floating), the length of the cable(s) and the frequency of the transmitted RF energy. The RF frequency is usually a fixed parameter which is not varied. Through utilization of the transformation behaviour of one or more cables, any impedance at the input on the generator side (input impedance) of the cable(s) can be transferred into any desired impedance at the output on the resonator side (output impedance) of the cable(s).

In some embodiments, the cable connection comprises a plurality of cables that are connected in parallel, the cable impedance and length of each of which are selected in such a manner that the output impedance of the RF generator is adjusted to the input impedance of the laser resonator. The cables connected in parallel preferably have the same length and the same cable impedance.

In some embodiments, a matchbox is provided on the resonator side, and the cable impedance and length of at least one cable of the cable connection are selected in such a manner that the output impedance of the RF generator is adjusted to the input impedance of the matchbox.

In another embodiment, a matchbox is provided on the generator side, and the cable impedance and length of at least one cable of the cable connection are selected in such a manner that the output impedance of the matchbox is adjusted to the input impedance of the laser resonator.

In some configurations, the cable connection includes at least one first cable interconnecting the RF generator and the laser resonator, and a second cable which is connected to the RF generator and has an open output or an output connected to ground. The cable impedance and length of the second cable are selected such that the output impedance of the RF generator is adjusted to the input impedance of the laser resonator.

It is possible to use coaxial lines (coaxial cables) and also strip lines for energy transfer and impedance transformation.

Each cable connection is advantageously flexible to permit trailing cable applications, enabling the laser resonator to be moved relative to the RF generator.

According to another aspect of the invention, a laser includes a laser resonator having an input impedance, an RF generator having an output impedance differing from the input impedance of the laser resonator, and a cable connection electrically interconnecting the RF generator and laser resonator. The cable connection includes a cable of an impedance and length selected to cause the output impedance of the generator to be adjusted to the input impedance of the resonator at a predetermined operating frequency of RF energy transmitted through the cable connection from the RF generator to the laser resonator.

According to another aspect, a laser includes a laser resonator, a matchbox connected to an input of the laser resonator and having an input impedance, an RF generator having an output impedance differing from the input impedance of the matchbox, and a cable connection electrically interconnecting the RF generator and matchbox. The cable connection includes a cable of an impedance and length selected to cause the output impedance of the generator to be adjusted to the input impedance of the matchbox at a predetermined operating frequency of RF energy transmitted through the cable connection from the RF generator to the matchbox.

In some configurations, the cable connection includes a plurality of cables connected in parallel, the impedance and length of each of which are selected such that the output impedance of the RF generator is adjusted to the input impedance of the matchbox. The cables may be identical, having the same length and the same cable impedance.

According to yet another aspect, a laser includes an RF generator, a matchbox connected to an output of the RF generator and having an output impedance, a laser resonator having an input impedance differing from the output impedance of the matchbox, and a cable connection electrically interconnecting the matchbox and laser resonator. The cable connection includes a cable of an impedance and length selected to cause the output impedance of the matchbox to be adjusted to the input impedance of the laser resonator at a predetermined operating frequency of RF energy transmitted through the cable connection from the matchbox to the laser resonator.

In some cases, the cable connection includes a plurality of cables connected in parallel, the impedance and length of each of which are selected such that the output impedance of the matchbox is adjusted to the input impedance of the laser resonator. The cables may be identical, having the same length and the same cable impedance.

Another aspect of the invention broadly features, in combination, an RF generator, a laser resonator, and a cable connection interconnecting the RF generator and the laser resonator. The cable connection comprises at least one cable directly connecting an output of a first component with an input of a second component, the output of the first component and the input of the second component exhibiting differing impedances. Notably, the cable is of an impedance and length selected to cause the output impedance of the first component to be adjusted to the input impedance of the second component at a predetermined operating frequency of RF energy transmitted through the cable connection from the RF generator to the laser resonator.

In some embodiments, the cable connection includes a plurality of cables which are connected in parallel, the impedance and length of each of which are selected such that the output impedance of the first component is adjusted to the input impedance of the second component. The cables may be identical, having the same length and the same cable impedance, for example.

In some cases, the first component is a matchbox connected to an output of the RF generator, and the second component is the laser resonator. In some other cases, the first component is the RF generator, and the second component is a matchbox connected to an input of the laser resonator.

In some embodiments, the cable connection includes at least one first cable interconnecting the first and second components, and a second cable with one end connected to the first component and an opposite end either open or connected to ground, the cable impedance and length of which are selected such that the output impedance of the first component is adjusted to the input impedance of the second component.

Another aspect of the invention features a method of exciting a laser resonator. The method includes providing an RF generator adapted to produce RF energy at a desired frequency, and connecting an output of the generator to an input of the resonator through a cable connection. Connecting the output of the generator to the input of the resonator includes directly connecting an output of a first component with an input of a second component with a cable of the cable connection, the first component exhibiting an output impedance differing from an input impedance of the second component, and selecting an impedance and length of the cable so as to adjust the output impedance of the first component to the input impedance of the second component at the desired frequency.

In some cases, connecting the output of the generator to the input of the resonator includes connecting the output of the first component to the input of the second component through a plurality of cables connected in parallel, and the impedance and length of each of the plurality of cables is selected such that the output impedance of the first component is adjusted to the input impedance of the second component.

In some embodiments, connecting the output of the generator to the input of the resonator includes attaching a matchbox at either a resonator end or a generator end of the cable connection, as either the first or second component.

In some examples, connecting the output of the generator to the input of the resonator includes directly connecting the output of the first component with the input of the second component with a first cable, connecting one end of a second cable to the first component and leaving an opposite end of the second cable either open or connected to ground. The impedance and length of the second cable is selected so as to adjust the output impedance of the first component to the input impedance of the second component at the desired frequency.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1a shows an arrangement with one single cable;

FIG. 1b shows an arrangement with one single cable and one matchbox between cable and laser resonator on the resonator side;

FIG. 1c shows an arrangement with one single cable and one matchbox between RF generator and cable on the generator side;

FIG. 2 shows an arrangement with four cables connected in parallel; and

FIG. 3 shows an arrangement with two cables.

Like reference symbols in the various drawings indicate like elements.

### DETAILED DESCRIPTION

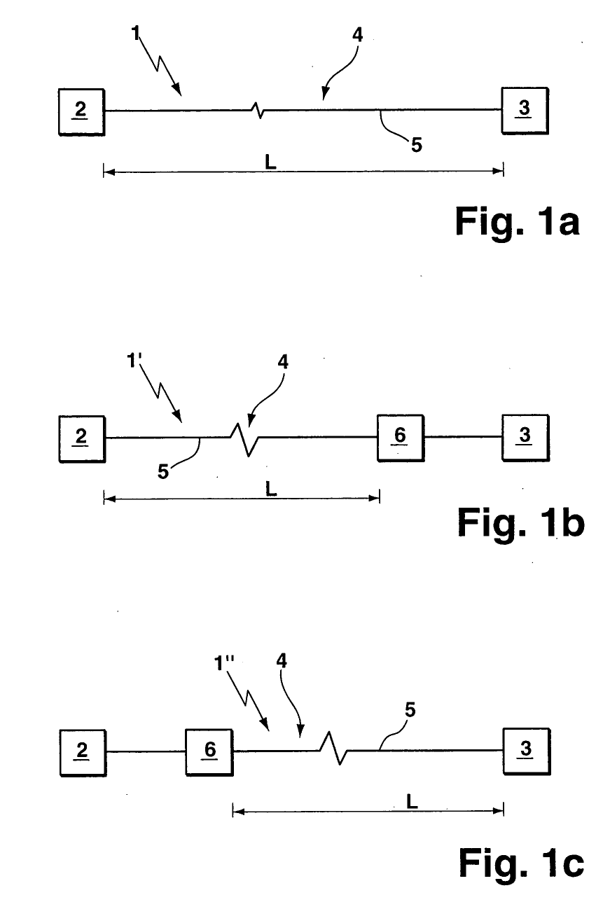

The laser and arrangement 1 shown in FIG. 1a comprises an RF generator 2, a laser resonator 3 and a cable connection 4 which is provided between the RF generator 2 and the laser resonator 3 and consists of one single cable 5. The laser resonator 3 is directly connected to the RF generator 2, i.e. without a matchbox. Disconnected, the output impedance of the RF generator 2 and the input impedance of the laser resonator 3 differ. The electric properties of the cable connection 4 depend on the output impedance of the RF generator 2, the cable impedance of the cable 5, the cable length L and the RF frequency of the RF generator 2. The cable impedance and length of the cable 5 are selected in such a manner that the output impedance of the RF generator 2 is adjusted to the input impedance of the laser resonator 3.

In addition to the length L of the cable 5, other lengths L+n·λ/2 may be used which differ from the determined cable length L by an integer multiple of half the wavelength λ.

The arrangement 1′ shown in FIG. 1b comprises an RF generator 2, a laser resonator 3 and a cable connection 4 which is provided between the RF generator 2 and the laser resonator 3 and consists of one single cable 5. On the resonator side, the cable 5 is connected to an internal or external matchbox 6 which is connected upstream of the laser resonator 3. Disconnected, the output impedance of the RF generator 2 and the input impedance of the matchbox 6 differ. The cable impedance and length L of the cable 5 are selected in such a manner that the output impedance of the RF generator 2 is adjusted to the input impedance of the matchbox 6. The matchbox 6 transforms the output impedance of the cable 5 to the input impedance of the laser resonator 3.

The arrangement 1″ shown in FIG. 1c comprises an RF generator 2, a laser resonator 3 and a cable connection 4 which consists of one single cable 5. On the generator side, the cable 5 is connected to a matchbox 6 which is connected downstream of the RF generator 2. The matchbox 6 transforms the output impedance of the RF generator to the input impedance of the cable 5. The output impedance of the matchbox 6 and the input impedance of the laser resonator 3 differ. The cable impedance and length L of the cable 5 are selected in such a manner that the output impedance of the matchbox 6 is adjusted to the input impedance of the laser resonator 3.

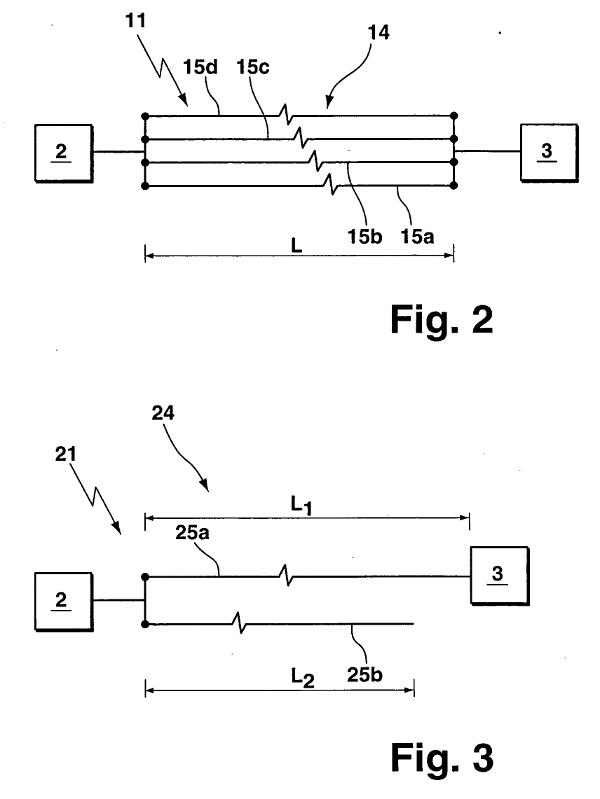

The arrangement 11 shown in FIG. 2 differs from the arrangement 1 merely in that the cable connection 14 consists of four cables 15a, 15b, 15c, and 15d which are connected in parallel. Coaxial cables with particular cable impedances, such as e.g. 50 ohms and 75 ohms, are inexpensive and readily available, whereas cables with other cable impedances must be specially produced and are correspondingly expensive. According to one solution, the desired cable impedance is therefore produced through connecting several cables in parallel. The cables which are connected in parallel may have different lengths and cable impedances. The four cables 15a, 15b, 15c, and 15d of the arrangement 11 have identical lengths and are flexible or pliable to permit trailing cable applications, wherein the laser resonator 3 is moved relative to the RF generator 2. The cable impedance and length L of each cable 15a, 15b, 15c, and 15d are selected in such a manner that the output impedance of the RF generator 2 is adjusted to the input impedance of the laser resonator 3.

The arrangement 21 shown in FIG. 3 comprises an RF generator 2, a laser resonator 3 and a cable connection 24 which is provided between the RF generator 2 and the laser resonator 3 and consists of two cables 25a and 25b. The cable 25a of the cable connection 24 has a length L₁ and connects the RF generator 2 and the laser resonator 3. The second cable 25b of the cable connection 14 has a length L₂. One end of the cable 25b is connected to the RF generator 2 and the other end has an open output.

The energy transfer and impedance transformation functions are performed separately by the cables 25a and 25b of the cable connection 24. The cable 25a transfers energy from the RF generator 2 to the laser resonator 3, and the cable 25b transforms the output impedance of the RF generator 2 into the input impedance of the laser resonator 3. The length L₂ and cable impedance of the cable 25b are selected in such a manner that the output impedance of the RF generator 2 is adjusted to the input impedance of the laser resonator 3. This arrangement is advantageous in that the length L₁ of the cable 25a between RF generator 2 and laser resonator 3 is a free parameter. The length L₁ can therefore be selected to ensure optimum ignition behaviour of the laser.

The cable 25b of the cable connection 24 which has an open output in FIG. 3 may alternatively be connected to ground. Both variants offer the possibility of impedance transformation, wherein the associated required cable lengths differ. While short cable lengths L₂ are sufficient for cables which are connected to ground, cables with an open output require cable lengths which are larger by λ/2.

A number of embodiments of the invention have been described. Nevertheless, it will be understood that various modifications may be made without departing from the spirit and scope of the invention. Accordingly, other embodiments are within the scope of the following claims.

What is claimed is:

1. A laser comprising
a laser resonator having an input impedance;
an RF generator having an output impedance differing from the input impedance of the laser resonator; and
a cable connection electrically interconnecting the RF generator and laser resonator;
wherein the cable connection includes a cable of an impedance and length selected to cause the output impedance of the generator to be adjusted to the input impedance of the resonator at a predetermined operating frequency of RF energy transmitted through the cable connection from the RF generator to the laser resonator.

2. The laser of claim 1, wherein the cable connection comprises a plurality of cables connected in parallel, the impedance and length of each of which are selected such that the output impedance of the RF generator is adjusted to the input impedance of the laser resonator.

3. The laser of claim 2, wherein the cables are identical, having the same length and the same cable impedance.

4. The laser of claim 1, wherein the cable connection comprises at least one first cable interconnecting the RF generator and the laser resonator, and a second cable with one end connected to the RF generator and an opposite end either open or connected to ground, the cable impedance and length of which are selected such that the output impedance of the RF generator is adjusted to the input impedance of the laser resonator.

5. A laser comprising
a laser resonator;
a matchbox connected to an input of the laser resonator and having an input impedance;
an RF generator having an output impedance differing from the input impedance of the matchbox; and
a cable connection electrically interconnecting the RF generator and matchbox;
wherein the cable connection includes a cable of an impedance and length selected to cause the output impedance of the generator to be adjusted to the input impedance of the matchbox at a predetermined operating frequency of RF energy transmitted through the cable connection from the RF generator to the matchbox.

6. The laser of claim 5, wherein the cable connection comprises a plurality of cables connected in parallel, the impedance and length of each of which are selected such that the output impedance of the RF generator is adjusted to the input impedance of the matchbox.

7. The laser of claim 6, wherein the cables are identical, having the same length and the same cable impedance.

8. A laser comprising
an RF generator;
a matchbox connected to an output of the RF generator and having an output impedance;
a laser resonator having an input impedance differing from the output impedance of the matchbox; and
a cable connection electrically interconnecting the matchbox and laser resonator;
wherein the cable connection includes a cable of an impedance and length selected to cause the output impedance of the matchbox to be adjusted to the input impedance of the laser resonator at a predetermined operating frequency of RF energy transmitted through the cable connection from the matchbox to the laser resonator.

9. The laser of claim 8, wherein the cable connection comprises a plurality of cables connected in parallel, the impedance and length of each of which are selected such that the output impedance of the matchbox is adjusted to the input impedance of the laser resonator.

10. The laser of claim 9, wherein the cables are identical, having the same length and the same cable impedance.

11. In combination,
an RF generator;
a laser resonator; and
a cable connection interconnecting the RF generator and the laser resonator,
wherein the cable connection comprises at least one cable directly connecting an output of a first component with an input of a second component, the output of the first component and the input of the second component exhibiting differing impedances; and
wherein the cable is of an impedance and length selected to cause the output impedance of the first component to be adjusted to the input impedance of the second component at a predetermined operating frequency of RF energy transmitted through the cable connection from the RF generator to the laser resonator.

12. The combination of claim 11, wherein the cable connection comprises a plurality of cables which are connected in parallel, the impedance and length of each of which are selected such that the output impedance of the first component is adjusted to the input impedance of the second component.

13. The combination of claim 12, wherein the cables are identical, having the same length and the same cable impedance.

14. The combination of claim 11, wherein the first component comprises a matchbox connected to an output of the RF generator, and wherein the second component is the laser resonator.

15. The combination of claim 11, wherein the first component is the RF generator, and wherein the second component comprises a matchbox connected to an input of the laser resonator.

16. The combination of claim 11, wherein the cable connection comprises at least one first cable interconnecting the first and second components, and a second cable with one end connected to the first component and an opposite end either open or connected to ground, the cable impedance and length of which are selected such that the output impedance of the first component is adjusted to the input impedance of the second component.

17. A method of exciting a laser resonator, the method comprising
providing an RF generator adapted to produce RF energy at a desired frequency; and
connecting an output of the generator to an input of the resonator through a cable connection, including
directly connecting an output of a first component with an input of a second component with a cable of the cable connection, the first component exhibiting an output impedance differing from an input impedance of the second component; and
selecting an impedance and length of the cable so as to adjust the output impedance of the first component to the input impedance of the second component at the desired frequency.

18. The method of claim 17, wherein
connecting the output of the generator to the input of the resonator comprises connecting the output of the first component to the input of the second component through a plurality of cables connected in parallel; and
selecting the impedance and length comprises selecting the impedance and length of each of the plurality of cables such that the output impedance of the first component is adjusted to the input impedance of the second component.

19. The method of claim 17, wherein connecting the output of the generator to the input of the resonator includes attaching a matchbox at either a resonator end or a generator end of the cable connection as the first or second component.

20. The method of claim 17, wherein connecting the output of the generator to the input of the resonator includes
directly connecting the output of the first component with the input of the second component with a first cable; and
connecting one end of a second cable to the first component and leaving an opposite end of the second cable either open or connected to ground; and wherein
selecting the impedance and length comprises selecting the impedance and length of the second cable.
